(19) United States
(12) Patent Application Publication
(10) Pub. No.: US 2005/0223640 A1
(43) Pub. Date: Oct. 13, 2005

(54) Plant marking tag

(75) Inventors: Walter J. Hall, Canton, OH (US); Jeffrey T. Kissinger, Wadsworth, OH (US)

Correspondence Address: HAHN LOESER & PARKS, LLP, One GOJO Plaza, Suite 300, AKRON, OH, 44311-1076, US

(73) Assignee: Landmark Plastic Corporation

(21) Appl. No.: 11/088,234

(22) Filed: Mar. 23, 2005

Related U.S. Application Data
(60) Provisional application No. 60/555,472, filed on Mar. 23, 2004.

(51) Int. Cl. A01G 9/02

(52) U.S. Cl. 47/65.6

(57) ABSTRACT

A plant tag having a body and a central leg which is to be inserted into a slot formed in a pot and two side legs which are to be inserted inside the pot into the growing media. The central leg comprises one or more indentations and/or tabs for resisting removal when the central leg is inserted into a slot on a pot.

This application claims priority from provisional patent application Ser. No. 60/555,472, filed Mar. 23, 2004, the disclosure of which is hereby incorporated by reference.

### TECHNICAL FIELD

The present invention is directed to a plant container and tag assembly. More particularly, the present invention relates to a plant container and a tag where the tag stands upright when attached to the pot and/or in growing media in the pot and resists inadvertent removal from the pot and/or growing media.

### BACKGROUND OF THE INVENTION

It is common in the horticultural industry to use tags of various types to identify the type of plant in a particular container. Usually, such tags are made of plastic and include a lower tapered end for insertion into the growing media in a pot or a slit or slot in the pot itself. The top end may include an indentation or crease to add stiffness to the tag. One of the main problems with these prior art tags is that the tags tend to slump or fall over while positioned in the pot so that they are not easily seen by a potential purchaser. In other instances, prior art tags may fall back into the plant foliage. This not only obstructs a customers view of the tag, but it may retard growth or otherwise damage the plant. These prior art tags are also easily removed from the growing media in the pot during transport or from handling by consumers. Once the tag is lost, consumers will not purchase the plant, because they cannot be certain of the identity of the growing plant. Further, some retailers are now requiring that tags be “locked” in the pot so that a tag from an expensive plant cannot easily be exchanged for a tag from a less expensive plant.

### SUMMARY OF THE INVENTION

In a first embodiment of the present invention, a plant tag comprises: a body; a central leg operably attached to the body, the central leg extending from a central portion of the body; a means for preventing removal of the tag from a pot, the means consuming a portion of the central leg; and at least one side leg operably attached to the body, the side leg extending from the body adjacent the central leg.

In a second embodiment of the present invention, a tagged pot comprises: a pot having a central cup-like recess and a lip surrounding a top end of the central recess, wherein the lip contains at least one perforation; and a plant tag having: a body; a central leg operably attached to the body, the central leg extending from a central portion of the body and being inserted into the at least one perforation; a means for preventing removal of the tag from the pot, the means consuming a portion of the central leg; and at least one side leg operably attached to the body, the side leg extending from the body adjacent the central leg.

In a third embodiment of the present invention, a method of tagging a pot comprises: providing a pot having a central cavity and a lip extending from the cavity, wherein the lip contains a slot; and placing a tag having: a body; at least one central leg operably attached to the body, the central leg extending from the body and having at least one notch; and at least one side leg operably attached to the body, the side leg extending from the body adjacent the central leg.

### BRIEF DESCRIPTION OF THE DRAWINGS

FIG. 1 is a front view of a tag in accordance with the present invention;

FIG. 2 is a front view of a tag and pot assembly in accordance with the present invention; and

FIG. 3 is a side cross-sectional view of a tag and pot assembly in accordance with the present invention.

### DETAILED DESCRIPTION OF THE INVENTION

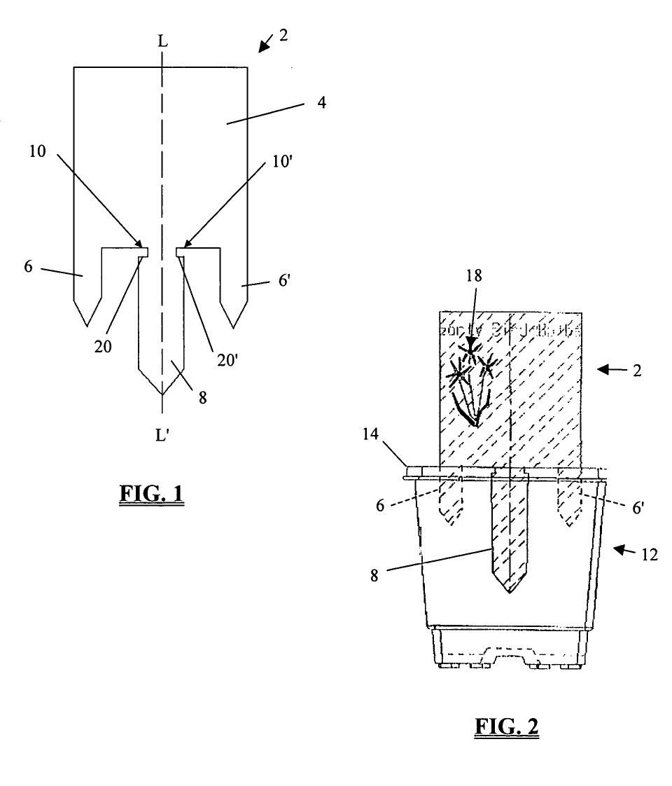

Referring to FIG. 1, there is shown a plant tag 2, embodying the present invention. Tag 2 is made of polypropylene or polystyrene, or any other suitable material, such as plastic or other polymeric materials, laminated paper, or cardboard, and may be stamped and die cut from a sheet of material in an integral manufacturing step. In the present embodiment, tag 2 comprises a body 4 and a stake-like, tapered, or pointed central leg 8 extending downwardly from the center of the body 4, where the extended end of leg 8 is pointed like an arrow. It is contemplated that central leg 8 may not be stake-like, and instead may have a squared or rounded extended end, or extended end may comprise two or more points or arrows. Further, it is contemplated that central leg 8 may extend in a uniform or tapered fashion (width and/or thickness). In the present embodiment, central leg 8 is integral with the tag body 4. Central leg 8 may optionally include at least one indentation or notch 10. In the embodiment shown in FIG. 1, two indentations 10 and 10′ are formed on opposite edges of central leg 8. In the present embodiment, the at least one indentation 10 is positioned adjacent to a lower edge of body 4. However, the at least one indentation may be alternatively positioned at a lower point on central leg 8.

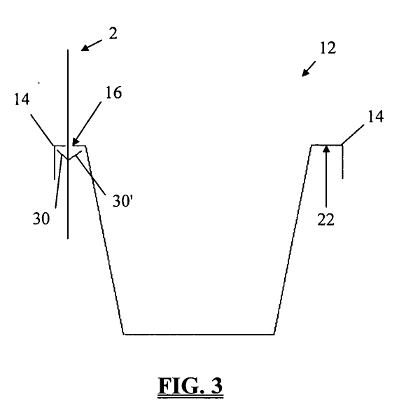

The tag of the present invention also includes at least one stake-like, tapered, or pointed side leg 6 extending downwardly from body. In the present embodiment as shown in FIGS. 1 and 2, the tag 2 includes two integral side legs 6 and 6′ extending downwardly on opposite sides of tag body 4. In the present embodiment, the side legs 6 and 6′ are shorter than the central leg. 8. In other embodiments, the side legs 6 and 6′ may be the same length or longer than central leg 8. In the present embodiment, the tag body 4, may be creased or folded along centerline L-L′. This crease or fold increases the stiffness and stability of the tag when it is positioned in a pot and/or soil.

FIGS. 2 and 3 illustrate a tag and pot assembly in accordance with the present invention. In the present embodiment, pot 12 is a polymeric thermoformed pot, commonly used by growers to prepare plants for sale. The tag of the present invention could be used with any type of grower's pot, regardless of the materials used or the method of formation. Pots 12, generally having a central recess for placing plants and/or soil, in accordance with the present invention have a lip 14 at a top end thereof. In the present embodiment, a slot 16 is formed in the lip 14 by punching out or otherwise removing a section of material from the lip 14. In an alternative embodiment, a slit could be made in the lip 14 by simply slicing a small section of the lip 14.

Information 18 about the plant growing in the pot is placed on one of the faces of the tag body 4. Such information 18 may include, but is not limited to, a picture of a plant of the same type, the common name of the plant, the scientific name of the plant, the grower or retailers name and contact information, relevant trademarks, or any other information that growers or sellers of plants may deem relevant can be placed on the tag.

In use, as shown in FIGS. 2 and 3, the tag 2 is positioned so that the central leg 8 is positioned through perforation (or slot) 16, the central leg 8 extending along the outside of pot 12. At least one of the side legs 6 and 6′ are positioned inside the pot in the growing media, with both legs 6, 6′ being so positioned in the present embodiment. In one embodiment, the central leg 8 can be positioned so that at least one indentation (or notch) 10 or 10′ is positioned adjacent to an end of perforation 16. In this position, the tag 2 will resist removal as the lower edge 20 or 20′ of the indentation 10 or 10′ abuts against the inner (or bottom) surface 22 of lip 14. It should be understood that, in some embodiments, perforation 16 and both indentations 10 and 10′ may interact to restrain removal of tag 2 from pot 12. It should be noted that perforation 16 may be a slot, a slit, or any other perforation capable of accepting central leg 8. In another embodiment of the invention, each side of the central leg 8 may also include one or more small cuts to create one or more tabs (such as 30 and 30′) on opposite sides of the central leg 8, whether or not indentations 10 and 10′ exist. The tabs 30, 30′ may be bent in a direction towards one of the faces of the tag 2 so that they restrain upward movement of the tag 2 out of the perforation 16 on the pot. In the embodiment shown in FIG. 3, the tabs 30, 30′ are bent in opposite directions along a horizontal axis to restrain movement of the tag out of the pot. However, other arrangements of the tabs are within the scope of the present invention, such as being bent along a vertical axis.

Although the invention has been described herein with reference to the present embodiments, it will become apparent to those skilled in the art that various modifications of the present embodiments of the invention as described herein can be made without departing from the spirit or scope of the invention as defined by the appended claims.

1. A plant tag comprising:
a body;
a central leg operably attached to the body, the central leg extending from a central portion of the body;
a means for preventing removal of the tag from a pot, the means consuming a portion of the central leg; and
at least one side leg operably attached to the body, the side leg extending from the body adjacent the central leg.

2. The plant tag of claim 1, wherein the central leg is integral with the body.

3. The plant tag of claim 1, wherein the central leg has two opposing notches.

4. The plant tag of claim 1, wherein the said at least one notch is located adjacent the body.

6. The plant tag of claim 1, wherein the central leg has a pointed terminal end.

7. The plant tag of claim 1, wherein the central leg includes at least one tab formed by bending a cut portion of the central leg.

8. The plant tag of claim 1, wherein the said at least one side leg is integral with the body.

9. The plant tag of claim 1, wherein the said at least one side leg has a pointed terminal end.

10. The plant tag of claim 1, further comprising two side legs, each located on opposing sides of the central leg.

11. The plant tag of claim 1, wherein the said at least one side leg extends in a direction substantially parallel to the central leg.

12. The plant tag of claim 1, wherein the said at least one side leg is shorter than the central leg.

13. The plant tag of claim 1, wherein the tag is formed from a polypropylene or polystyrene.

14. The plant tag of claim 1, further comprising a bend line, extending linearly and centrally through the extension of the central leg and the body.

15. The plant tag of claim 14, wherein the tag is bent along the bend line.

16. The plant tag of claim 1, wherein the means for preventing removal of the tag from a pot comprises an opposing pair of indentations on the central leg.

17. The plant tag of claim 16, wherein the indentations are located adjacent the body.

18. The plant tag of claim 1, wherein the means for preventing removal of the tag from a pot includes an opposing pair of tabs on the central leg, the tabs being formed by cuts and capable of being bent away from the central leg; and

19. The plant tag of claim 1, wherein the tag is bent along a bend line, the line extending linearly and centrally through the central leg and the body.

20. A method of tagging a pot, comprising:
providing a pot having a central cavity and a lip extending from the cavity, wherein the lip contains a perforation; and
placing a tag into the pot, the tag having: a body; at least one central leg operably attached to the body, the central leg extending from the body and having at least one notch; and at least one side leg operably attached to the body, the side leg extending from the body adjacent the central leg, wherein the at least one central leg is placed into the perforation of the pot.

21. The method of tagging according to claim 20, wherein the tag resists removal from the pot when a bottom surface of the notch contacts an inner surface of the lip.

22. A tagged pot comprising:
a pot having a central cup-like recess and a lip surrounding a top end of the central recess, wherein the lip contains at least one perforation; and
a plant tag having: a body; a central leg operably attached to the body, the central leg extending from a central portion of the body and being inserted into the at least one perforation; a means for preventing removal of the tag from the pot, the means consuming a portion of the central leg; and at least one side leg operably attached to the body, the side leg extending from the body adjacent the central leg.
